(19) United States
(12) Patent Application Publication
(10) Pub. No.: US 2011/0163677 A1
(43) Pub. Date: Jul. 7, 2011

(54) LIGHTING DEVICE, LIGHTING AND LIGHTING METHOD

(76) Inventors: Emmanuel Baret, Marseille (FR); Gaëtan Grignon, Saint Mitre les Remparts (FR)

(21) Appl. No.: 12/995,309

(22) PCT Filed: May 26, 2009
(86) PCT No.: PCT/FR2009/000602

§ 371 Date: Mar. 21, 2011

(30) Foreign Application Priority Data
May 30, 2008 (FR) 0802968

(51) Int. Cl. H05B 37/02; H04B 3/00

(52) U.S. Cl. 315/152; 315/313; 315/294; 375/257

(57) ABSTRACT

The present invention relates to a lighting device and a lighting method, in particular for a swimming pool.

It relates in particular to a lighting device, particularly a lighting device for a swimming pool, which comprises:
at least one control unit capable of controlling the operation of at least one spotlight;
at least one spotlight, each spotlight being itself associated with a light source;
at least one receiver, itself associated with one or more spotlight(s); and
a external electric power supply;

said control unit capable of being adapted to send control instructions to each receiver by powerline communication (PLC), and said receiver being capable of including a means for decoding said instructions.

The present invention relates to a lighting device and a lighting method. It can be applied to any lighting device envisageable and is in particular perfectly adapted to the lighting of a swimming pool. Thus the invention more particularly relates to a lighting device located in a damp environment.

Currently, swimming pool lighting is provided according to regulations by means of spotlights supplied with electric power that is generally low-voltage for safety reasons. Generally, each spotlight contains a bulb and if it is desired to have different colours, or to vary the colours over time, it is necessary to equip the swimming pools with different spotlights comprising bulbs of different colours and to provide a control device capable of switching the spotlights on and off as desired. The inflexibility of use and the number of devices to be provided in order to obtain the desired result are a significant drawback that can slow down installation projects.

Furthermore, it is known that the lighting of a swimming pool, apart from its straightforward lighting function, can also reflect artistic and decorative endeavour or at the very least, entertainment. There is therefore a need for multi-colour lighting devices, optionally modular, without a concomitant increase in the number of spotlights installed around or in the swimming pool.

The purpose of the present invention is to respond to this need and to remedy the drawbacks of the standard devices in use.

To this end, the present invention relates, according to a first aspect, to a lighting device, particularly a lighting device for a swimming pool, which comprises:
at least one control unit capable of controlling the operation of at least one spotlight;
at least one spotlight, each spotlight being itself associated with a light source;
at least one receiver, itself associated with one or more spotlight(s); and
an external electric power supply;

said control unit being capable of sending control instructions to each receiver by powerline communication (PLC), and said receiver being capable of including a means for decoding said instructions.

Thanks to these provisions, the instructions between the control unit and each spotlight can be complex and have a high information content. A person skilled in the art will understand that these provisions make it possible that on a supply network, optionally already in place, said control unit can send a stream of instructions which as a whole or individually are intended for each or all the spotlights (group of spotlights), through the receiver(s) associated with said spotlight (or said group of spotlights), said receiver(s) being capable of decoding the information, capturing the information intended for the spotlight (or the group of spotlights) associated therewith and commanding said spotlight (or group of spotlights), which itself independently includes means for responding to the commands.

One of the advantages of the present invention resides in the fact that as the lighting device according to the invention is capable of being kept permanently switched on, it can contain multiple programming and/or control means, capable of operating independently of each other.

A person skilled in the art knows the principle of the carrier current which consists in brief of superimposing, over an electric current of a given frequency, a low-power signal that has a higher frequency.

This second signal is propagated over the electrical installation and can be received and decoded remotely. Thus the PLC signal is received by any PLC receiver which is present on the same electrical power network.

Conventionally, PLCs are classified into two categories according to the data rate offered:
high data-rate PLCs use multi-carrier modulations of the type modulating digital signals by distribution of orthogonal frequencies (OFDM, Orthogonal Frequency Division Modulation), DMT (Discrete Multi Tone) or COFDM (Coded Orthogonal Frequency Division Multiplexing);
low data-rate PLCs use quite simple modulation techniques, for example a few carriers (but a single one at a time) for frequency modulation.

According to the invention, a low data rate carrier current is preferably used.

According to a particular embodiment of the device according to the invention, the latter can comprise means capable of controlling the light source(s) according to the desired duration of lighting and/or the intensity of the lighting required, and/or the desired colour of the lighting, and/or means capable of varying the intensity and/or the colour of the lighting, optionally as a function of time and/or a sound, such as a piece of music for example.

According to this embodiment, each light source can receive a particular command, independent of that of another light source, relative to its level of light intensity and/or the duration of lighting.

According to yet a further particular embodiment of the device according to the invention, the spotlights can be equipped with at least 1 light source.

By light source is understood here any means capable of producing a light, whether clear or coloured, said means being capable by itself of producing a light of a single colour or lights of different colours.

There can be mentioned for example, incandescent bulbs or light-emitting diodes, also known as LEDs. According to the invention, LEDs will preferably be used.

Among the LEDs it can be envisaged to use LEDs that can emit a light of a single colour, or LEDs that can emit several colours, such as for example an RGB LED capable of emitting a red and/or green and/or blue light. According to the invention, preferably RGB LEDs will be used.

A person skilled in the art knows that such RGB LEDs are capable of emitting simultaneously or independently, according to the intensity of the current sent to each colour emitter contained in the LED, 1 or 2 or 3 primary colours (red, green or blue), which when emitted simultaneously and according to the intensity of each, can make it possible to obtain a infinite number of colours. For example if a red LED, a blue LED and a green LED, or a RGB LED is used, it is possible to obtain up to 7 different colours (red, blue, green, magenta by combining red and blue, yellow by combining red and green, cyan by combining green and blue and white by combining red, green and blue), as well as, owing to the possibly modulation of the current delivered to each colour source, an infinite number of hues of these colours.

Again according to this embodiment of the invention, it is possible to use LEDs having low power (less than 1 watt) or high power (greater than or equal to 1 watt). According to the invention, preferably high-power LEDs will be used. It should be noted that according to the invention, it is possible to replace the LEDs by incandescent lamps of different colours in order to obtain the same result. A person skilled in the art will know how to define the type of light source to be used in the device according to the invention as a function of the constraints that he will have to overcome.

The device according to the invention provides a number of advantages.

Regardless of the embodiment chosen, it can be adapted to an existing installation without the need for re-wiring said installation. Moreover if necessary, the dimensions of the spotlights of the device according to the invention can easily be adapted to the dimensions of the spotlights of the installation as they were before replacement, again making it possible to reduce costs and the time required for adapting an existing installation using a device according to the invention.

When the device uses LEDs, the lighting can give a very high-power performance.

Use of LEDs can allow significant savings to be made due to the lower electricity consumption required for their use in comparison with incandescent bulbs. The life time of LEDs is much longer than for incandescent bulbs, once again conferring a definite saving.

Finally, the use of several colours, associated with the use of a control unit issuing commands that are identical or different for each colour, makes it possible to obtain a large number of colour hues.

According to the invention, said receiver can be a single one and associated with one or more spotlight(s). But it is possible that in the device according to the invention, each spotlight is associated with a receiver.

According to yet a further embodiment of the invention, it is possible for a network including a first single receiver associated with one or more spotlight(s), said spotlights being capable of being mounted in series or in parallel, and one or more networks including as many receivers as spotlights, each receiver being associated with a spotlight, to coexist in the same device, thus dependant on a single supply and a single control unit.

According to the invention, said control unit can be capable of sending instructions intended for each spotlight, particularly instructions relating to each of the LEDs constituting the bulb associated with said receiver.

In this provision, the device according to the invention can make it possible, simultaneously or independently, to change the colour of the spotlights and/or to select the mode of operation of said spotlights.

According to the invention the spotlights can operate according to several modes such as for example fixed or flashing colour lighting, lighting in programmed sequences, lighting in random sequences and/or rhythmic lighting to music.

According to yet a further embodiment of the invention, the control unit can comprise a receiver for remote control and/or an audio input, capable of allowing the light to be modulated according to the rhythm of a piece of music.

According to a further embodiment, the device according to the invention can comprise a remote control capable of transmitting messages, advantageously to the control unit and/or each spotlight, each message capable of including a spotlight identifier and each spotlight capable of including means for receiving signals from the remote.

As a result of these provisions, a single remote control can be able to remotely control several spotlights.

According to a further embodiment, said device can moreover comprise at least one input for signals originating from a sensor, for example an ambient light intensity sensor and/or a presence sensing device around and/or in the swimming pool.

Of course, a person skilled in the art understands on reading the above that each of the embodiments envisaged can be adapted to the device according to the invention, either independently of the other embodiments, or in combination with one or more other embodiments according to the invention.

According to a second aspect, the present invention relates to a lighting method, particularly for lighting a swimming pool, implementing a device such as described previously, comprising at least one control unit capable of controlling the operation of at least one spotlight, at least one spotlight, each spotlight being itself associated with a light source, at least one receiver, itself associated with one or more spotlight(s), and an external electric power supply, said control unit being capable of sending control instructions to each receiver by powerline communication (PLC), and said receiver being capable of including a means for decoding said instructions, characterized in that said method includes, for each lighting period:
a step of switching on the lighting means,
a lighting period according to a previously-chosen given mode, and
afterwards, a step of switching off the lighting means.

Other advantages, aims and features of the present invention will become apparent from the following description, provided for the purposes of explanation and non-limitatively with reference to the attached figure in which a limited number of spotlights has been shown for the sake of clarity of the figures. Nevertheless, the present invention is not limited to this number of spotlights.

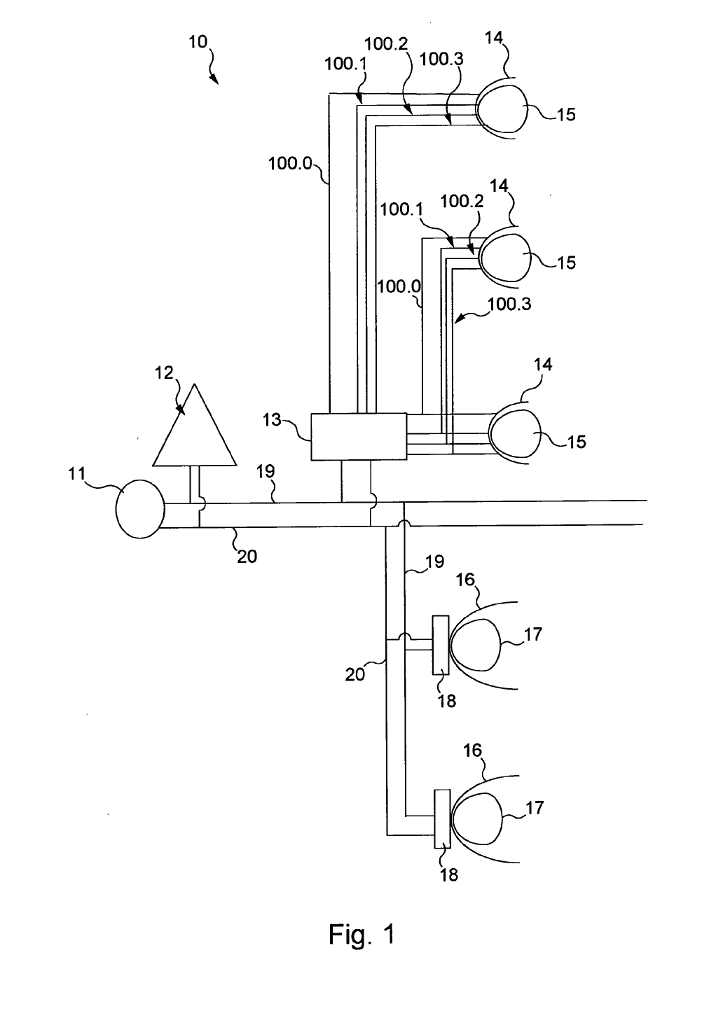

FIG. 1 shows an embodiment of the invention representing a lighting device (10) according to the invention, supplied by an external supply (11), including a control unit (12), combining 2 networks, one comprising a single receiver (13) connected by electrical connections to spotlights (14), associated respectively with light sources (15) and the other comprising the spotlights (16), associated respectively with light sources (17) and each of the receivers (18). The supply is connected to each receiver (13, 18) by electrical connections (19, 20). The connection (100.0) corresponds to the common supply of the assembly and the connections (100.1, 100.2 and 100.3) correspond to the supplies to each light source, the connections (100.1, 100.2 and 100.3) each corresponding to the supply to one colour of an RGB LED.

In the case of the spotlights (16), the connections (100.0, 100.1, 100.2 and 100.3) are integrated into the spotlight.

The control unit (12) is of a known type and is capable of being programmed manually via a keypad and a user interface, or by a computerized system via a removable memory card or a wired or wireless link.

The electrical connections (19, 20) are adapted to convey control instructions to the receivers (13 and 18).

The light sources (15, 17) are RGB LEDs of a known type and are capable of switching on or off under the control of the receivers (13 and 18).

The external electric power supply (11) can be for example the EDF 230V mains supply or an electric accumulator or an electric battery or any AC or DC source of electricity or any independent device of the solar panel or other type. For example, in the case of a swimming pool, the supply will be a 12-volt alternating current.

1. Lighting device for a swimming pool, comprising:
at least one control unit capable of controlling the operation of at least one spotlight;
at least one spotlight, each spotlight being itself associated with a light source;
at least one receiver, itself associated with one or more spotlight(s); and
a external electric power supply;
said control unit being capable of sending control instructions to each receiver by powerline communication (PLC), and said receiver being capable of including a means for decoding said instructions.

2. Device according to claim 1, wherein said control units are adapted to switch said light source on or off.

3. Device according to claim 1, wherein the powerline communication (PLC) can be chosen from
a. high data-rate PLCs using multi-carrier modulations of the type modulating digital signals by distribution of orthogonal frequencies (OFDM, Orthogonal Frequency Division Modulation), DMT (Discrete Multi Tone) or COFDM (Coded Orthogonal Frequency Division Multiplexing);
b. low data rate PLCs using quite simple modulation techniques, for example a few carriers (but a single one at a time) for frequency modulation.

4. Device according to claim 1, further comprising means capable of controlling the lighting according to the desired duration of lighting and/or the intensity of the lighting according to the desired intensity, and/or the choice of the colour of the lighting and/or varying the intensity and/or the colour of the lighting, the latter as a function of time and/or a sound, such as a piece of music for example.

5. Device according to claim 1, wherein the spotlights are equipped with at least one light source.

6. Device according to claim 5, wherein each of said at least one light source receives a particular command, independent of that of another colour source, said command relating to its light intensity level and/or to the duration of lighting.

7. Device according to claim 1, wherein the light source is an incandescent bulb or a light-emitting diode or LED.

8. Device according to claim 1, wherein the light source is capable of emitting a given colour or capable of emitting several colours.

9. Device according to claim 7, wherein the light emitting diode is low-power (less than 1 watt) or high-power (greater than or equal to 1 watt), preferably a high-power diode.

10. Device according to claim 5, wherein the light source emits a red and/or green and/or blue light.

11. Device according to claim 10, wherein the light source is constituted by a red LED, a blue LED and a green LED.

12. Device according to claim 10, wherein the light source is constituted by a RGB LED.

13. Device according to claim 1, wherein the control unit is capable of sending instructions to each receiver, particularly instructions relating to each of the light sources constituting the spotlight associated with said receiver.

14. Device according to claim 1, wherein the control unit comprises a receiver for remote control and/or an audio input.

15. Device according to claim 1, further comprising a remote control capable of transmitting messages, advantageously to the control unit and/or each spotlight.

16. Device according to claim 1, further comprising at least one input of signals originating from a sensor, for example an ambient light sensor and/or a presence sensing device around and/or in the swimming pool.

17. Lighting method, particularly for lighting a swimming pool, implementing a lighting device such as described in claim 1, comprising at least one control unit capable of controlling the periods of operation of at least one spotlight and at least one spotlight comprising at least one receiver associated with at least one bulb, wherein said method includes, for each lighting period:
a. a step of switching on these lighting means,
b. a lighting period according to a given previously-chosen mode and afterwards, a step of switching off the lighting means.
